(19) United States
(12) Patent Application Publication
(10) Pub. No.: US 2007/0073801 A1
(43) Pub. Date: Mar. 29, 2007

(54) Electronic mail system, apparatus and removable storage means suitable for such a system

(76) Inventors: Maarten Peter Bodlaender, Eindhoven (FR); Henricus Xavier Willems, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/550,045

(22) PCT Filed: Mar. 18, 2004
(86) PCT No.: PCT/IB04/00948

§ 371 Date: Sep. 21, 2005

(30) Foreign Application Priority Data
Mar. 26, 2003 (EP) 03290761.0

(51) Int. Cl. G06F 15/16

(52) U.S. Cl. 709/203

(57) ABSTRACT

This electronic mail system comprises an apparatus (1) having a device for a connection to an electronic mail service (18) in Internet world. The apparatus (1) comprises a drive (42) for an optical disc (5), which has the facility for writing/reading this optical disc. The disc can contain the mail and its archives. It is possible to manage the mail with various apparatus even they have no provision for an Internet connection.

The present invention relates to an electronic mail system comprising at least an apparatus having a device to be connected to an electronic mail service.

This apparatus finds many applications, notably for serving users who wish to maintain contact with their E-mail.

Such an apparatus is disclosed in the Japanese patent document JP 200273493. This known apparatus relates to music players having E-mail facilities.

The present invention proposes a system of the type mentioned above, which provides advantages in the handling of the mail without using complicated mail apparatuses.

An electronic mail system according to the invention comprises, at least:
an apparatus having a device to be connected to an electronic mail service, said apparatus comprising:
   a receptacle for receiving a removable data storage means,
   writing/reading means for reading and/or writing said storage means,
   connecting means for a connection to a mail service,
   mail managing means for managing mail,
      which system further comprises:
a removable data storage means.

The removable storage means provides at least a facility for mail management. This measure enables the mail to be handled in various locations by means of apparatuses which are not of the same type. The connecting means may even be omitted in these other apparatuses. The user can read his mail and write or record mails, which will be sent some other time with an adequate apparatus.

The invention also proposes an apparatus which is suitable for such a mail system, and a removable data storage means suitable for the system.

These and other aspects of the invention are apparent from and will be elucidated, by way of non-limitative example, with reference to the embodiment(s) described hereinafter.

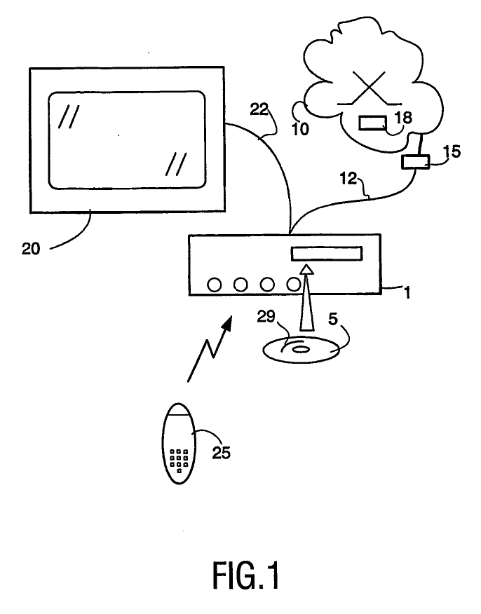

FIG. 1 shows an electronic mail system in accordance with the invention.

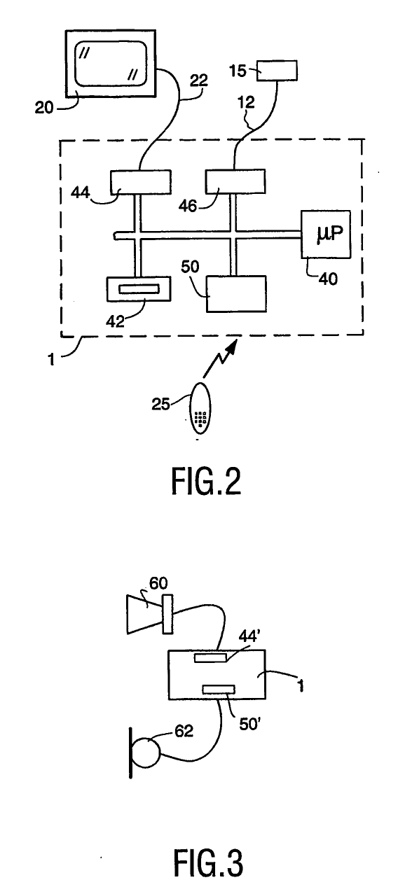

FIG. 2 shows the structure of the system shown in FIG. 1.

FIG. 3 shows another embodiment of an electronic system in accordance with the invention.

FIG. 1 shows a mail system having an apparatus 1, in which a removable data carrier 5, notably an optical disc, can be placed. In a preferred embodiment, this optical disc is a SFFO disc (Small Form Factor Optical disc). This apparatus comprises means for a connection to the web network 10. This connection is provided with a link 12, for instance a telephone line to an Internet access service 15, which is necessary for accessing the web 10. A mail server 18 can be contacted for the purpose of handling the user's mail. The apparatus, in this example, cooperates with a usual TV apparatus 20 to which it is connected by a cable 22. A remote control device 25 carries out the control of the apparatus 1. The apparatus 1 is of a type, which allows a connection to an E-mail service. A dedicated command is provided for this connection. This command may be established by a permanent command or may be programmed by a command file contained in the removable data carrier 5. The location of this file is referenced 29. This command file is launched when the apparatus recognizes it, so that one of the buttons of the remote command 25 is dedicated to the function: ‘send this E-mail’. The apparatus may have functions other than mail handling, such a function may be a DVD recorder function.

FIG. 2 shows a structure of the apparatus 1. It is formed from a microprocessor unit 40 in which the usual elements are provided: memory for data, memory for program lines, and so on. This unit 40 is the core of the apparatus and handles all the working of the apparatus. The reference 42 indicates the drive for removable data storage means constituted by an optical disc. This drive 42 provides a receptacle for the optical drive. The apparatus comprises some interface circuits: a display circuit 44 for connection to the TV apparatus 20 via the cable 22, a modem device 46 for connection to the Internet access service 15 which provides access to the mail server 18, and infrared interface circuit 50 for receiving the commands from the remote control device 25.

FIG. 3 shows another embodiment of the invention, wherein the apparatus comprises other interface circuits for enabling a voice dialogue. The TV apparatus is replaced with a loudspeaker 60. The remote control device is not needed. The voice of the user is sufficient to give commands to the apparatus. A microphone 62 is provided for receiving these voice commands. So, the interface circuit 44 is replaced by a voice synthesizer 44′ and the interface circuit 50 by a voice analyzer 50′.

The operation of the apparatus is the following.

When the optical disc is inserted in the drive 42, the command file 29 is read so that the user can access his mail by pushing a button of the remote control or one of those on the apparatus. The contents of the mail are displayed on the screen of the TV apparatus 20 and are stored in the optical disc.

The measures of the invention render it possible to prepare an E-mail on a disc. This E-mail is only sent when the storage means is placed in an Internet-connected apparatus. The advantage of this is that the users can access their E-mail on any device capable of handling the storage medium. It becomes possible for the users to easily file their E-mail, and by placing the storage medium in a safe place to open the E-mail (filing) as an application for optical storage. Apparatuses that do not have an Internet connection may also be used to read archived E-mails and to prepare E-mails to be sent later.

Thus the removable storage contains the necessary contacting information (location of E-mail server password).

The scope of the invention covers those apparatuses which are not able to be connected to the mail server but have the possibility to read and write mails in the removable storage means, so it can be temporarily disconnected from the Internet (e.g. when on the move), and connected later.

1- An electronic mail system comprising at least:
an apparatus having a device to be connected to an electronic mail service, said apparatus comprising:
a receptacle for receiving a removable data storage means,
writing/reading means for reading and/or writing said storage means,
connecting means for a connection to a mail service,
mail managing means for managing mail,
which system further comprises:
a removable data storage means.

2- A mail system as claimed in claim 1 comprising mail means for storing at least part of the contents of the mail in said removable data storage means.

3- A mail system as claimed in claim 1 comprising archiving means for archiving the mail in a file in said removable data storage means.

4- A mail system as claimed in claim 1, wherein said removable data storage means are constituted by an optical disc.

5- A mail system as claimed in claim 1, wherein the mail server is accessible via a network such as the Internet.

6- An apparatus suitable for electronic mail and comprising:
a device to be connected to an electronic mail service,
a receptacle for receiving a removable data storage means,
writing/reading means for reading and/or writing said storage means,
connecting means for a connection to a mail service,
mail managing means for managing mail.

7- A removable data storage means suitable for an apparatus as claimed in claim 1 in which data relating to mail are stored.

8- A removable data storage means suitable for an apparatus as claimed in claim 1 in which data relating to the filing of mail are stored.

9- A removable data storage means suitable for an apparatus as claimed in claim 1 in which data relating to mail and to the filing mail are stored.

10- A removable data storage means as claimed in claim 7, comprising a file for configuring the apparatus for managing the mail.

11- An apparatus suitable for an electronic mail system comprising at least:
an apparatus having a device to be connected to an electronic mail service, said apparatus comprising:
a receptacle for receiving a removable data storage means,
writing/reading means for reading and/or writing said storage means,
connecting means for a connection to a mail service,
mail managing means for managing mail,
which system further comprises:
a removable data storage means and for a removable data storage means as claimed in claim 9, comprising configuring means for configuring said apparatus for mail managing by launching said configuring file.

12- A mail system as claimed in claim 1, wherein mail managing means for managing mail comprise display means for managing the mail.

13- A mail system as claimed in claim 1, wherein mail managing means for managing mail comprises acoustic means for managing the mail.

14- A method of managing mail, which involves the following steps of:
using a first apparatus which comprises:
a receptacle for a removable data storage means,
writing/reading means for reading and/or writing said storage means,
connecting means for a connection to a mail service,
mail managing means for managing mail dealt with by the removable data storage means,
inserting a removable data storage means,
connecting to a mail server,
storing at least part of the contents of the mail in said removable storage means,
removing said removable storage means for subsequent use with another or with the same apparatus.
